(19) United States
(12) Patent Application Publication
(10) Pub. No.: US 2008/0313142 A1
(43) Pub. Date: Dec. 18, 2008

(54) CATEGORIZATION OF QUERIES

(75) Inventors: Chong Wang, Beijing (CN); Xing Xie, Beijing (CN); Zhisheng Li, (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/763,306

(22) Filed: Jun. 14, 2007

(51) Int. Cl. G06F 17/30

(52) U.S. Cl. 707/3; 707/E17.001

(57) ABSTRACT

Determination of a target category associated with a business listings query is provided. A query categorization system initially generates a mapping of internal categories of the query categorization system to target categories of a search engine service. The query categorization system receives a business listings query and identifies business listings that match the query. The query categorization system identifies an internal category associated with each matching business listing. The query categorization system then identifies from the mapping the target categories that correspond to the identified internal categories. The query categorization system selects one of the identified target categories as the category to be associated with the query.

### BACKGROUND

Many search engine services, such as Google and Yahoo, provide for searching for information that is accessible via the Internet. These search engine services allow users to search for display pages, such as web pages, that may be of interest to users. After a user submits a search request (i.e., a query) that includes search terms, the search engine service identifies web pages that may be related to those search terms. To quickly identify related web pages, the search engine services may maintain a mapping of keywords to web pages. This mapping may be generated by “crawling” the web (i.e., the World Wide Web) to identify the keywords of each web page. To crawl the web, a search engine service may use a list of root web pages to identify all web pages that are accessible through those root web pages. The keywords of any particular web page can be identified using various well-known information retrieval techniques, such as identifying the words of a headline, the words supplied in the metadata of the web page, the words that are highlighted, and so on. The search engine service identifies web pages that may be related to the search request based on how well the keywords of a web page match the words of the query. The search engine service then displays to the user links to the identified web pages in an order that is based on a ranking that may be determined by their relevance to the query, popularity, importance, and/or some other measure.

Search engine services also support local searches in which a user can search for local business listings. The search engine service may interact with a business listings directory service to obtain business listings for local businesses that match a query. A business listings query may be submitted with an indication of a location (e.g., zip code) to define the area of the local search. Each business listing may include the name, address, telephone number, link to home web page, and so on of the business. When a search engine service submits a query and location to the business listings directory service, the directory service searches its business listings directory for business listings that match the query near that location. The business listings directory service then provides the matching business listings to the search engine service, which may display the business listings as search results to a user.

Business listings directory services also provide categorization services for queries submitted as business listings searches. For example, the query “pizza restaurants” may be in the business category of “Italian restaurants.” A search engine service may use the category of a query in various applications. The search engine service can use the category to help select an appropriate advertisement to be placed along with the search results, to help determine how to present the search results to the user, to help the user refine the query, and so on. For example, if the category is “Italian restaurants,” the search engine service may search for advertisements that are to be placed with the keyword “Italian restaurant.” Based on the word “Italian” in the category, the search engine service may also retrieve a map of Italy and display as a background to the business listings. The search engine service may present the user with a list of sub-categories (e.g., “Sicilian restaurants”) of “Italian restaurants” so that the user can refine the query by sub-category.

A query categorization service of a business listings directory service may provide a custom taxonomy of business categories or may use a standard taxonomy, such as the Standard Industrial Classification (“SIC”) or the North American Industry Classification System (“NAICS”). These taxonomies provide a hierarchical categorization of businesses. Although these taxonomies may provide a comprehensive way to categorize businesses, the search engine services may have developed their own taxonomies over time to meet the needs of their users searching for business listings. As a result, each search engine service may prefer to use its own taxonomy rather than the taxonomy used by a query categorization service.

### SUMMARY

Determination of a target category associated with a business listings query is provided. A query categorization system initially generates a mapping of internal categories of the query categorization system to target categories of a search engine service. The query categorization system has access to a business listings directory with business listings categorized according to the internal categories. The query categorization system receives a business listings query and identifies business listings that match the query. The query categorization system identifies the internal category associated with each matching business listing. The query categorization system then identifies from the mapping the target categories that correspond to the identified internal categories. The query categorization system selects one of the identified target categories as the category to be associated with the query.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a display page that illustrates search results of a business listings query in one embodiment.

FIG. 2 is a block diagram that illustrates components of the query categorization system in some embodiments.

FIG. 3 is a flow diagram that illustrates the processing of the match taxonomy component of the query categorization system in one embodiment.

FIG. 4 is a flow diagram that illustrates the processing of the find matching target category component of the query categorization system in one embodiment.

FIG. 5 is a flow diagram that illustrates the processing of the identify target categories component of the query categorization system in one embodiment.

FIG. 6 is a flow diagram that illustrates the processing of the identify target categories from listings component of the query categorization system in one embodiment.

FIG. 7 is a flow diagram that illustrates the processing of the identify internal categories of listings component of the query categorization system in one embodiment.

FIG. 8 is a flow diagram that illustrates the processing of the identify target categories of internal categories component of the query categorization system in one embodiment.

FIG. 9 is a flow diagram that illustrates the processing of the identify target categories from web pages component of the query categorization system in one embodiment.

FIG. 10 is a flow diagram that illustrates the processing of the generate scores for target categories component of the query categorization system in one embodiment.

FIG. 11 is a flow diagram that illustrates the processing of the filter target categories component of the query categorization system in one embodiment.

FIG. 12 is a flow diagram that illustrates the processing of the replace target categories component of the query categorization system in one embodiment.

### DETAILED DESCRIPTION

Determination of a target category associated with a business listings query is provided. In some embodiments, a query categorization system initially generates a mapping of internal categories of the query categorization system to target categories of a search engine service. For example, an internal category of “pizza restaurants” may be mapped to the target category of “Italian restaurants.” The query categorization system also has access to a business listings directory with business listings categorized according to the internal categories. The query categorization system receives a business listings query and identifies business listings that match the query. For example, the query may be “pizza parlor” and the business listings may be the pizza restaurants near the location specified along with the query. The query categorization system identifies the internal category associated with each matching business listing. The query categorization system then identifies from the mapping the target categories that correspond to the identified internal categories. The query categorization system selects one of the identified target categories as the category to be associated with the query. For example, the query categorization system may select the target category based on the number of internal categories of the matching business listings that map to each target category.

In some embodiments, the query categorization system generates a mapping of internal categories to target categories based on a term-frequency-by-inverse-document-frequency (“tf*idf”) metric. The query categorization system calculates similarity scores for each internal category between text describing the internal category and text describing each target category. The query categorization system maps an internal category to the target category with a similarity score that indicates its description is most similar to the description of the internal category. In certain cases, a similarity score may indicate that an internal category is not similar to any target category (e.g., a score of 0). In such case, the query categorization system may map the internal category to a target category to which an ancestor internal category maps. For example, if an internal category of “Sicilian restaurants” is not similar to any target category and the parent internal category of “Sicilian restaurants” maps to the target category of “Italian restaurants,” then the query categorization system may map the internal category of “Sicilian restaurants” to the target category of “Italian restaurants.”

The query categorization system may represent a similarity score used in generating the mapping from internal categories to target categories as follows:

$$sim ( {TC}_{j} , {IC}_{k} ) = \frac{\vec{{TC}_{j}} \cdot \vec{{IC}_{k}}}{\vert \vec{{TC}_{j}} \vert \times \vert \vec{{IC}_{k}} \vert} = \frac{{\sum }_{i = 1}^{t} {w}_{i , j} \times {w}_{i , k}}{\sqrt{{\sum }_{i = 1}^{t} {w}_{i , j}^{2}} \times \sqrt{{\sum }_{i = 1}^{t} {w}_{i , k}^{2}}} \qquad ( 1 )$$

where sim(TCⱼ,ICₖ) represents the similarity score between the text of target category TCⱼ and the text of internal category ICₖ, \vec{TCⱼ} and \vec{TCₖ} each represent a term feature vector with an entry for each possible word set to a weight for that word in the text, |\vec{TCⱼ}| and |\vec{ICₖ}| represent the norm of the term feature vectors, w_{i,j} represents the weight of the ith word in target category j, and w_{i,k} represents the weight of the ith word in internal category k. The query categorization system represents the weights as follows:

w_{i,j}=f_{i,j}×idfᵢ (2)

where f_{i,j} represents the term frequency of the ith word within target category j and idfᵢ is the inverse document frequency for the ith word. The query categorization system may represent the term frequency as follows:

$${f}_{i , j} = \frac{{freq}_{i , j}}{{max}_{i} {freq}_{i , j}} \qquad ( 3 )$$

where freq_{i,j} represents the number of occurrences of the ith word within target category j and maxᵢ freq_{i,j} represents the maximum number of occurrences of a word within target category j. The query categorization system may represent the inverse document frequency as follows:

$${idf}_{i} = log \frac{N}{{n}_{i}} \qquad ( 4 )$$

where N represents the number of target categories and nᵢ represents the number of target categories that contain the ith word. The query categorization system uses similar equations to calculate the weights for the internal categories.

After calculating the similarity between an internal category and each target category, the query categorization system maps the internal category to the target category with the highest similarity score. The query categorization system also calculates a confidence score indicating confidence that the mapping of the internal category to the target category is correct. In some embodiments, the query categorization system may use the similarity score to represent the confidence as follows:

match(ICₖ)=arg_max_{—}j[sim(TCⱼ, ICₖ) (5)

where match(ICₖ) represents the similarity score between the internal category ICₖ and the target category with the highest similarity score.

In some embodiments, the query categorization system categorizes a query based on categories identified from both a business listings search and a web page search. To identify target categories based on a business listings search, the query categorization system searches for business listings that match the query and identifies the internal category of each business listing. The query categorization system then uses the mapping to identify the target categories associated with each business listing. The identified target categories are candidate target categories for the query. The query categorization system then filters the candidate target categories to select target categories to be associated with the query.

To identify target categories based on a web page search, the query categorization system submits a query to a web page search engine service and receives the search results. The search results contain an entry for each matching web page with text describing the web page (e.g., a snippet) and a link to the web page. The query categorization system then calculates a similarity score between the text of each entry of the search results and the text of each target category. In some embodiments, the query categorization system uses the term-frequency-by-inverse-document-frequency metric to indicate the similarity. The query categorization system then filters the target categories to select target categories to be associated with the query based on the similarity score, which may also be considered a confidence score that the target category is the correct target category for the query.

The query categorization system may use various techniques to combine the target categories selected based on the business listings search and selected based on the web page search. For example, the query categorization system may categorize the query using the selected target categories, if any, resulting from the business listings search. If, however, no target categories were selected (e.g., none passed the filter), then the query categorization system may categorize the query using the selected target categories resulting from the web page search. If no target categories were selected by either search, then the query categorization system returns an indication that no matching target category was found. In some embodiments, the query categorization system may weight the selected target categories of the business listings search and the selected target categories of the web page search. The query categorization system applies the weights to the confidence scores to generate a weighted confidence score. The query categorization system then selects target categories with the highest weighted confidence scores as corresponding to the query.

The query categorization system may use various filtering techniques to select the candidate target categories for the query. The filtering schemes may include a top-k scheme, a confidence threshold scheme, a normalized confidence threshold scheme, and a percentage normalized confidence threshold scheme. The top-k scheme selects the target categories with the highest confidence scores. The confidence threshold scheme selects the target categories with confidence scores higher than a threshold confidence level. The normalized confidence threshold scheme normalizes the confidence scores to between zero and one and then selects confidence scores that are higher than a normalized threshold. The percentage normalized confidence threshold scheme is similar to the normalized confidence scheme except that it selects candidate target categories with the highest normalized confidence scores until the aggregate of those confidence scores exceeds a threshold. One skilled in the art will appreciate that the various thresholds can be set based on empirical analysis of the results of the query categorization system.

Prior to applying any one of these schemes, the query categorization system may replace candidate target categories with their parent categories. The query categorization system attempts to replace child target categories with their parent target category when the confidence scores of the child target categories are distributed generally evenly. For example, the child target categories of the “Italian restaurants” target category may be “Sicilian restaurants,” “Northern Italian restaurants,” and “pizza restaurants.” If each one of these child target categories is identified as a candidate target category with approximately the same confidence score, then the query categorization system may replace the child target categories with the parent target category in the candidate target categories. In such a case, the parent target category may be a better choice as a candidate target category, because no one of the child target categories seems to be a better choice than any other. The query categorization system may measure the entropy in confidence scores among child target categories as follows:

$$H ( X ) = - {\sum }_{i = 1}^{n} ( P ( {X}_{i} ) {log}_{2} P ( {X}_{i} ) )$$

where H(X) represents the entropy score, n represents the number of child target categories, Xᵢ represents the confidence score of the ith child target category, and P(Xᵢ) represents the percentage of the confidence score for the ith child target category to the aggregate of the confidence scores for all the child target categories. The query categorization system then replaces the child target categories with a parent target category when the entropy score is above a threshold, which may be empirically learned.

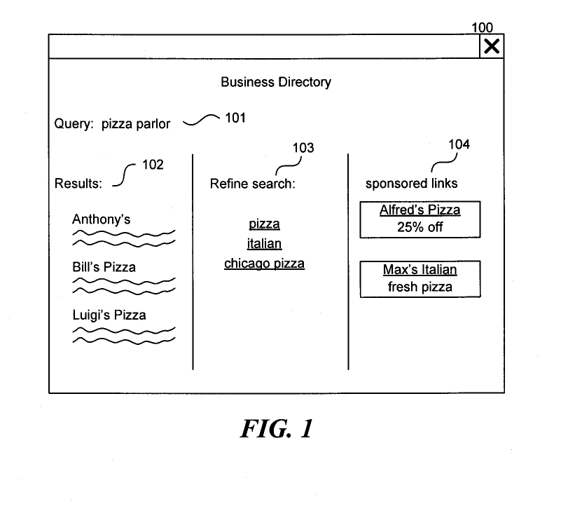

FIG. 1 is a display page that illustrates search results of a business listings query in one embodiment. Display page 100 includes a query area 101, a results area 102, a refine search area 103, and a sponsored links area 104. In this example, a user entered the query “pizza parlor” into the query area. The query was submitted to a business listings directory service and received results that are displayed in the results area. The business listings directory service may also use a query categorization system to categorize the query and return the target categories. In this example, the target categories are listed in the refine search area. A user can select a target category in the refine search area to further refine the query. For example, if the user selected the category “Chicago pizza,” then the search results may be limited to business listings that serve Chicago-style pizza. The categories may also have been used to identify advertisements that are displayed in the sponsored links area.

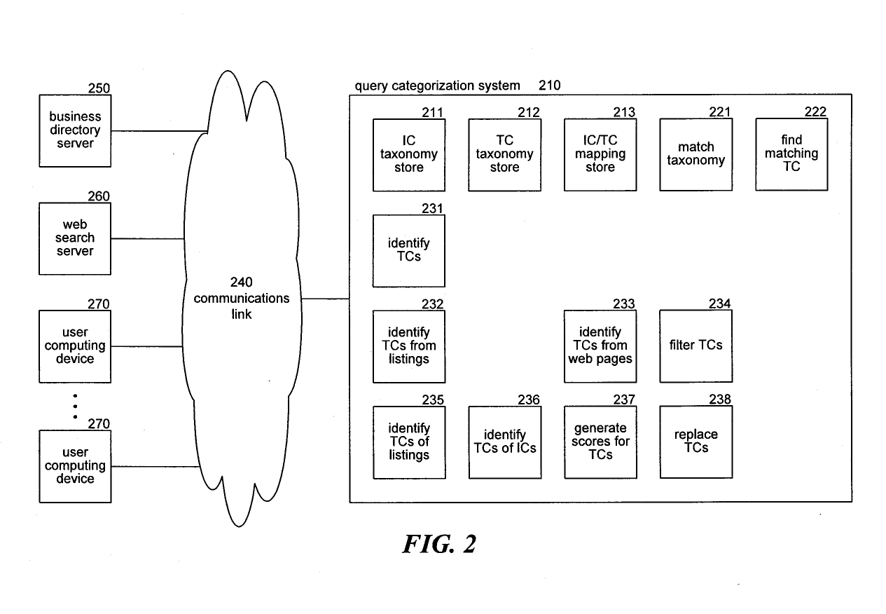

FIG. 2 is a block diagram that illustrates components of the query categorization system in some embodiments. The query categorization system 210 is connected to business directory servers 250, web search servers 260, and user computing devices 270 via a communications link 240. The business directory servers may input a query and output business listings that match the query. Alternatively, the business listings may be stored locally in a database of the query categorization system. The web search servers may input the query and output web page search results that match the query.

The query categorization system includes an internal taxonomy store 211, a target taxonomy store 212, and an internal category/target category mapping store 213. The internal taxonomy store contains a hierarchical organization of the internal categories, such as the SIC or the NAICS categories. The target taxonomy store contains a hierarchical organization of the target categories, such as those preferred by the providers of business listings search results. The internal category/target category mapping store contains a mapping from each internal category to a corresponding target category.

The query categorization system also includes a match taxonomy component 221 and a find matching target category component 222. The match taxonomy component 221 identifies the target category that most closely matches each internal category by invoking the find matching target category component. The match taxonomy component then stores the mapping in the internal category/target category mapping store.

The query categorization system also includes an identify target categories component 231, an identify target categories from listings component 232, an identify target categories from web pages component 233, a filter target categories component 234, an identify internal categories of listings component 235, an identify target categories of internal categories component 236, a generate scores for target categories component 237, and a replace target categories component 238. The identify target categories component searches for business listings and web pages using the query. The identify target categories component then invokes the identify target categories from listings component and the identify target categories from web pages component in parallel to identify candidate target categories for the query. The identify target categories component then invokes the filter target categories component to filter the target categories identified from the business listings and the target categories identified from the web pages. The identify target categories from listings component invokes the identify internal categories of listings component to identify the internal category of each listing and then invokes the identify target categories of internal categories component to identify the target categories for the internal categories. The identify target categories from web pages component invokes the generate scores for target categories component to generate similarity scores between each entry of the search result and each target category.

The computing device on which the query categorization system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the system, which means a computer-readable medium that contains the instructions. In addition, the instructions, data structures, and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the query categorization system may be implemented in and used with various operating environments that include personal computers, server computers, hand-held or laptop devices, multiprocessor systems, microprocessor-based systems, programmable consumer electronics, digital cameras, network PCs, minicomputers, mainframe computers, computing environments that include any of the above systems or devices, and so on.

The query categorization system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

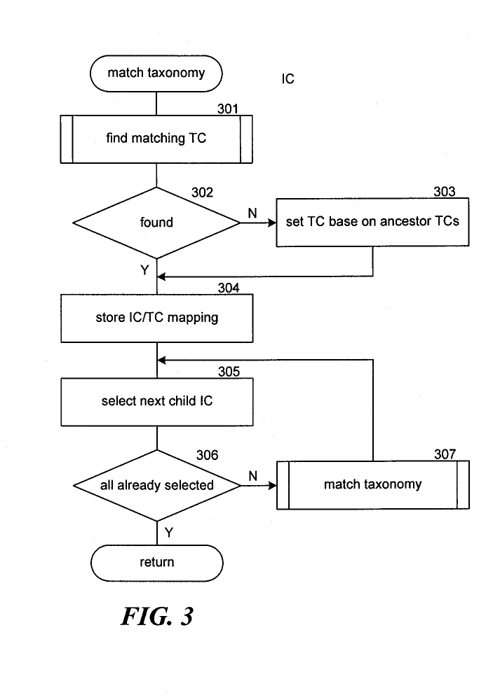

FIG. 3 is a flow diagram that illustrates the processing of the match taxonomy component of the query categorization system in one embodiment. The component is passed an internal category and identifies its target category and the target categories for its descended internal categories. The component is illustrated as a recursive routine that is initially passed the root internal category of the internal taxonomy. In block 301, the component invokes the find matching target category component to find the target category that matches the passed internal category. In decision block 302, if a matching target category was found, then the component continues at block 304, else the component continues at block 303. In block 303, the component sets the matching target category based on the target category found for an ancestor internal category. In block 304, the component stores the mapping of internal category to target category. In blocks 305-307, the component recursively invokes the match taxonomy component for each child internal category. In block 305, the component selects the next child internal category. In decision block 306, if all the child internal categories have already been selected, then the component returns, else the component continues at block 307. In block 307, the component invokes the match taxonomy component passing the selected child internal category and then loops to block 305 to select the next child internal category.

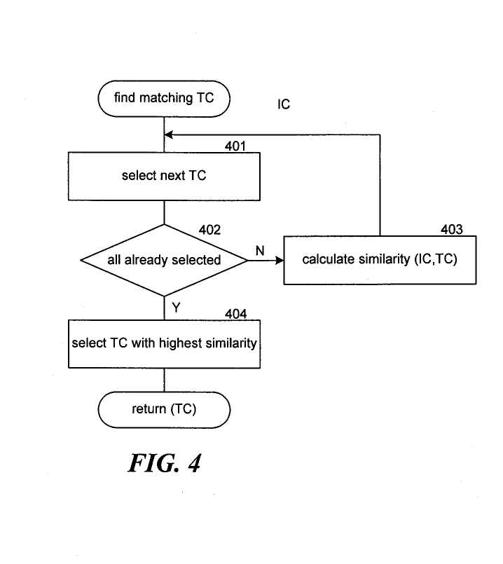

FIG. 4 is a flow diagram that illustrates the processing of the find matching target category component of the query categorization system in one embodiment. The component is passed an internal category and calculates the similarity between the internal category and each target category and then selects a matching target category as the target category with the highest similarity score. In block 401, the component selects the next target category. In decision block 402, if all the target categories have already been selected, then the component continues at block 404, else the component continues at block 403. In block 403, the component calculates the similarity between the internal category and the selected target category and then loops to block 401 to select the next target category. In block 404, the component selects a target category with the highest similarity score and then returns the target category.

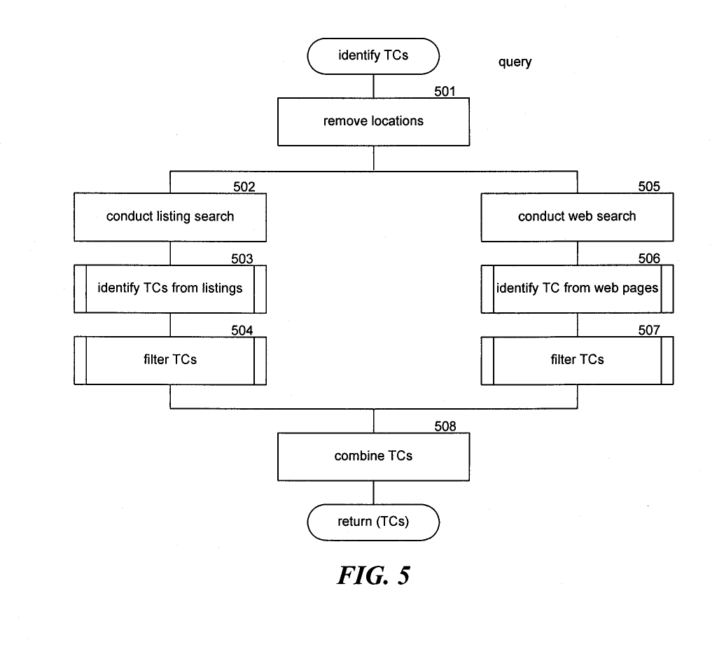

FIG. 5 is a flow diagram that illustrates the processing of the identify target categories component of the query categorization system in one embodiment. The component is passed a query and identifies target categories for the query. In block 501, the component removes any location terms from the query, such as New York, Los Angeles, Beijing, and so on, because queries for business listings typically have an associated location (e.g., zip code specification). In blocks 502-504, the component identifies target categories based on business listings. In blocks 505-507, the component identifies target categories based on web pages. The component may perform blocks 502-504 and blocks 505-507 in parallel. In block 502, the component conducts a business listings search using the query. In block 503, the component invokes the identify target categories from listings component to identify target categories from the business listings of the results. In block 504, the component invokes a filter target categories component to filter the target categories derived from the business listings. In block 505, the component conducts a web page search using the query. In block 506, the component invokes the identify target categories from web pages component to identify the target categories. In block 507, the component invokes the filter target categories component to filter the target categories derived from the web pages. In block 508, the component combines the target categories identified from the business listings and the web pages and then returns the combined categories.

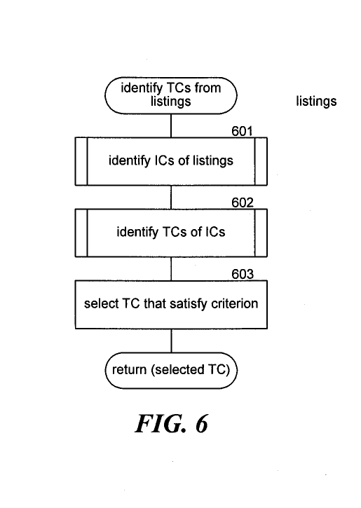

FIG. 6 is a flow diagram that illustrates the processing of the identify target categories from listings component of the query categorization system in one embodiment. The component is passed business listings and identifies the target categories of the business listings. In block 601, the component invokes the identify internal categories of listings component to identify the internal categories of the business listings. In block 602, the component invokes the identify target categories of internal categories component to identify the target categories. In block 603, the component selects the target categories that satisfy a selection criterion and returns the selected target categories as the candidate categories.

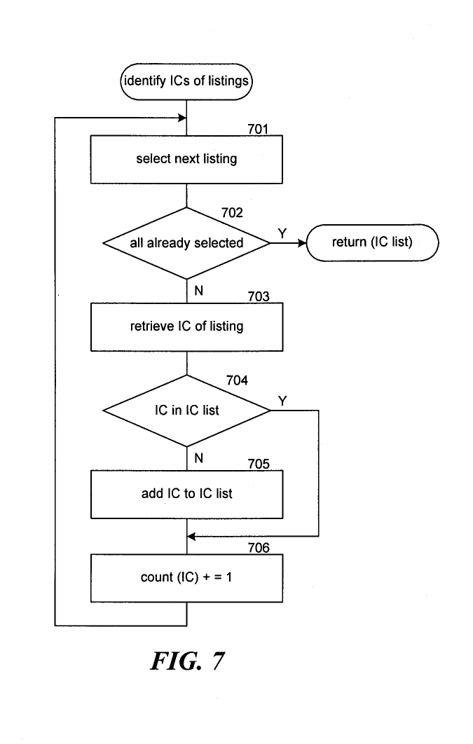

FIG. 7 is a flow diagram that illustrates the processing of the identify internal categories of listings component of the query categorization system in one embodiment. The component is passed listings and identifies the internal categories of the listings along with a count of the number of listings for each identified internal category. In block 701, the component selects the next listing. In decision block 702, if all the listings have already been selected, then the component returns an indication of the internal categories and their counts, else the component continues at block 703. In block 703, the component retrieves the internal category of the selected listing. In decision block 704, if the internal category is already in the list of internal categories, then the component continues at block 706, else the component continues at block 705. In block 705, the component adds the internal category to the list and initializes its count to zero. In block 706, the component increments the count of the internal category and then loops to block 701 to select the next listing.

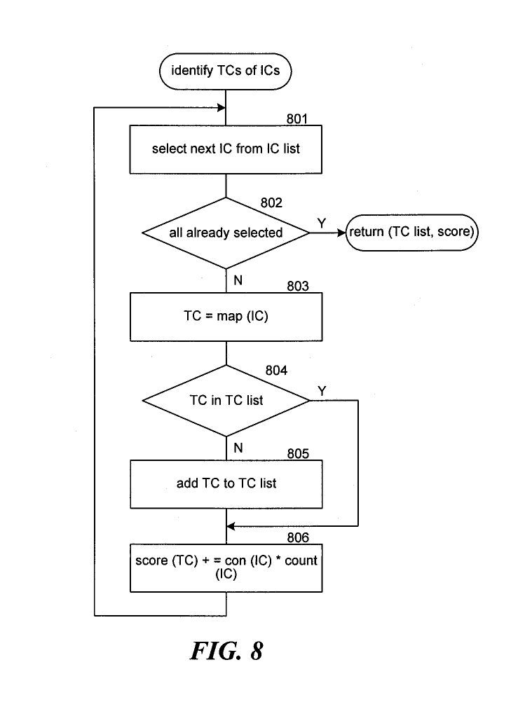

FIG. 8 is a flow diagram that illustrates the processing of the identify target categories of internal categories component of the query categorization system in one embodiment. The component inputs internal categories and their counts and returns a list of target categories and their scores. In block 801, the component selects the next internal category. In decision block 802, if all the internal categories have already been selected, then the component returns a list of the target categories and their scores, else the component continues at block 803. In block 803, the component identifies the target category for the internal category using the internal category/target category mapping store. In decision block 804, if the target category is already in the list of target categories, then the component continues at block 806, else the component continues at block 805. In block 805, the component adds the target category to the list of target categories and initializes its score to zero. In block 806, the component adds to the score for the target category, the confidence score for the internal category mapping to the target category multiplied by the count of the business listings in the search results for that internal category. The component then loops to block 806 to select the next internal category.

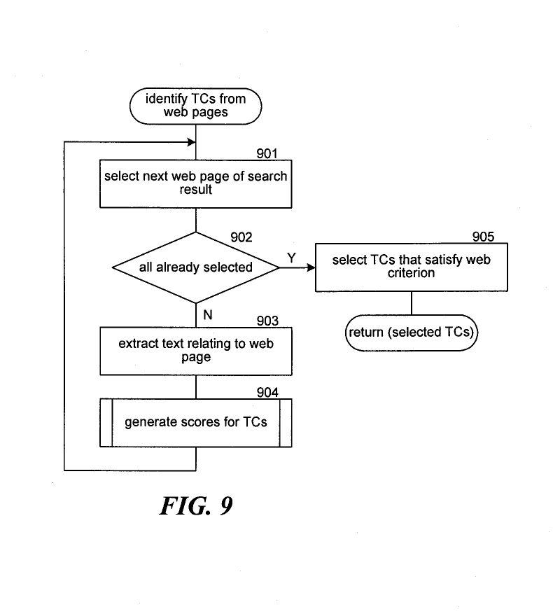

FIG. 9 is a flow diagram that illustrates the processing of the identify target categories from web pages component of the query categorization system in one embodiment. The component is passed the search result of a web page search and identifies candidate target categories. In blocks 901-904, the component generates scores for each combination of web page of the search result and target category. In block 901, the component selects the next web page of the search result. In decision block 902, if all the web pages have already been selected, then the component continues at block 905, else the component continues at block 903. In block 903, the component extracts text (e.g., a snippet) relating to the selected web page from the search result. In block 904, the component invokes the generate scores for target categories component passing the selected web page to generate scores for each target category. The component then loops to block 901 to select the next web page of the search result. In block 905, the component selects the target categories that satisfy a web page criterion and then returns the selected target categories as candidate target categories.

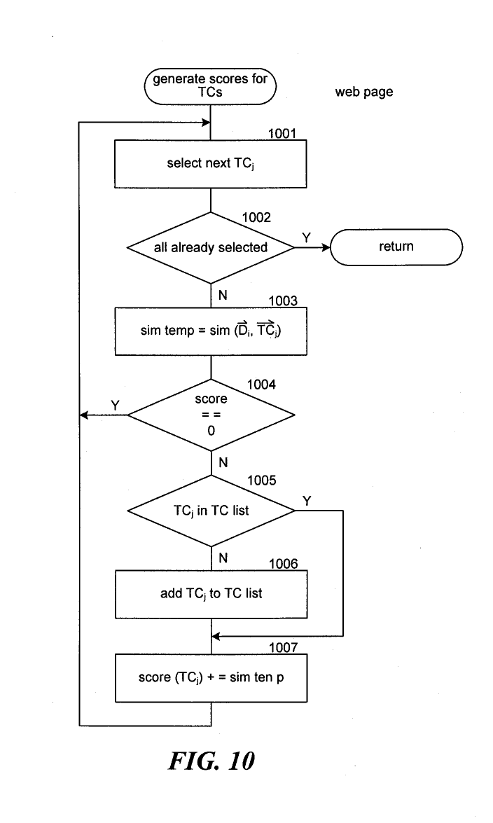

FIG. 10 is a flow diagram that illustrates the processing of the generate scores for target categories component of the query categorization system in one embodiment. The component is passed an indication of a web page and generates a similarity score for each target category. In block 1001, the component selects the next target category. In decision block 1002, if all the target categories have already been selected, then the component returns the scores for the target categories, else the component continues at block 1003. In block 1003, the component calculates a similarity score between the passed web page and the selected target category. In decision block 1004, if the similarity score is zero, the component loops to block 1001 to select the next target category, else the component continues at block 1005. In decision block 1005, if the selected target category is already in the list of target categories, then the component continues at block 1007, else the component continues at block 1006. In block 1006, the component adds the selected target category to the list of target categories and initializes its score to zero. In block 1007, the component increments the score of the selected target category by the similarity score and loops to block 1001 to select the next target category.

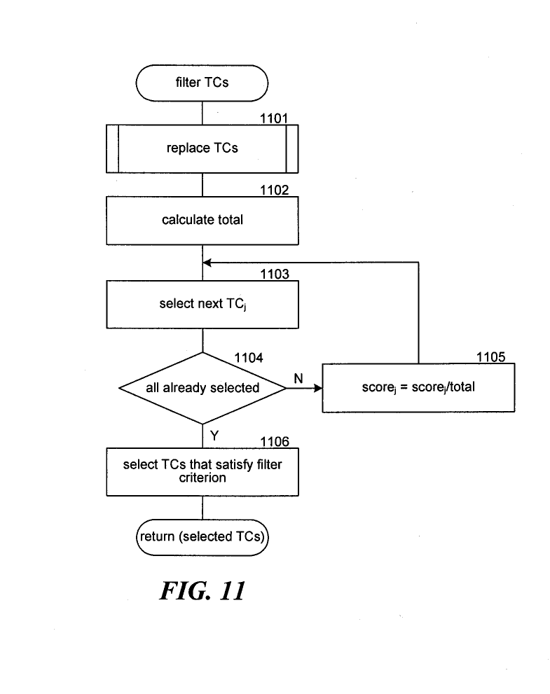

FIG. 11 is a flow diagram that illustrates the processing of the filter target categories component of the query categorization system in one embodiment. The component inputs candidate target categories and selects target categories that satisfy a filtering criterion. In this example, the component implements the normalized confidence threshold scheme. In block 1101, the component invokes the replace target categories component to replace child target categories with their parent target category based on an entropy analysis. In block 1102, the component calculates the total of the confidence scores for the candidate target categories. In blocks 1103-1105, the component loops calculating the normalized score for each candidate target category. In block 1103, the component selects the next candidate target category. In decision block 1104, if all the candidate target categories have already been selected, then the component continues at block 1106, else the component continues at block 1105. In block 1105, the component calculates the normalized score for the selected target category and then loops to block 1103 to select the next category. In block 1106, the component selects the candidate target categories whose normalized score satisfy the filter criterion. The component then returns the selected target categories.

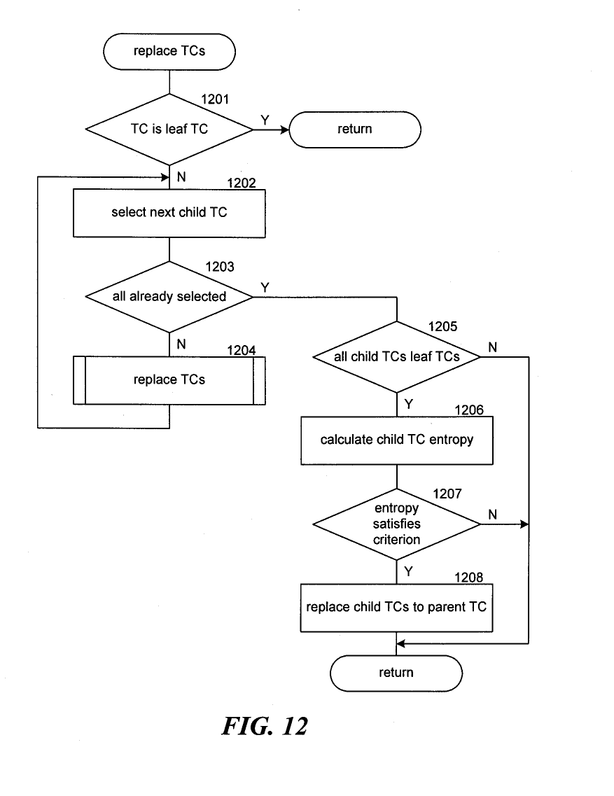

FIG. 12 is a flow diagram that illustrates the processing of the replace target categories component of the query categorization system in one embodiment. The component is illustrated as a recursive component that performs a depth first traversal of target taxonomy and replaces child candidate target categories with their parent target categories based on an entropy analysis. The component is initially passed the root target category of the target taxonomy. In decision block 1201, if the target category is a leaf target category, then the component returns, else the component continues at block 1202. In block 1202-1204, the component loops recursively invoking the replace target categories component for each child target category of the passed target category. In block 1202, the component selects a child target category. In decision block 1203, if all the child target categories have already been selected, then the component continues at block 1205, else the component continues at block 1204. In block 1204, the component invokes the replace target categories component recursively and then loops to block 1202 to select the next child target category. In blocks 1205-1208, the component determines whether to replace the candidate target categories that are child target categories of the passed target with the passed target category. In decision block 1205, if all the child target categories are leaf nodes, then the component continues at block 1206, else the component returns. In block 1206, the component calculates an entropy score for the child target categories. In decision block 1207, if the entropy score satisfies a replacement criterion, then the component continues at block 1208, else the component returns. In block 1208, the component replaces the candidate child target categories with their parent target category as a new candidate target category and then returns.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A method in a computing device for determining a target category associated with a query, the method comprising:
storing a mapping of internal categories to corresponding target categories;
identifying business listings associated with the query;
identifying internal categories associated with the identified business listings;
identifying from the mapping target categories corresponding to the identified internal categories; and
selecting an identified target category corresponding to the identified internal categories to be associated with the query.

2. The method of claim 1 wherein the identifying of business listings includes submitting the query as a search to a business listings directory and receiving business listings as results of the search.

3. The method of claim 1 wherein the storing of the mapping includes generating the mapping by calculating similarity between text associated with the internal categories and text associated with the target categories.

4. The method of claim 3 wherein the similarity is based on a term-frequency-by-inverse-document-frequency metric.

5. The method of claim 1 wherein the selecting of the identified target category includes generating a score for each identified target category, the score indicating similarity of text associated with the internal categories and text associated with the target category.

6. The method of claim 5 wherein the score for a target category is weighted based on number of business listings associated with an internal category that maps to the target category.

7. The method of claim 1 including identifying web pages associated with the query and identifying target categories associated with the identified web pages, wherein the selecting of an identified target category selects one of the identified target categories associated with the identified web pages.

8. The method of claim 7 wherein an identified target category associated with the identified web pages is selected when no identified target category associated with an internal category satisfies a filter criterion.

9. The method of claim 1 including selecting an advertisement based on the selected target category.

10. The method of claim 1 including allowing a user to refine the query based on the selected target category.

11. A computing device for determining a target category associated with a query, the device comprising:
a component that generates a mapping of internal categories to corresponding target categories;
a component that identifies, based on the mapping, target categories from internal categories associated with business listings associated with the query;
a component that identifies target categories from web pages of search results associated with the query; and
a component that selects an identified target category to be associated with the query.

12. The computing device of claim 11 wherein the component that generates the mapping calculates similarity between text associated with the internal categories and text associated with the target categories.

13. The computing device of claim 12 wherein the similarity is based on a term-frequency-by-inverse-document-frequency metric.

14. The computing device of claim 11 wherein the component that identifies target categories from internal categories submits the query to a business listings directory to identify business listings associated with the query.

15. The computing device of claim 11 wherein the component that identifies target categories from web pages submits the query to a search engine service.

16. The computing device of claim 15 wherein the component that identifies target categories from web pages calculates similarity between text associated with the target categories and text associated with the web pages.

17. The computing device of claim 11 including a component that removes location terms from the query.

18. A computer-readable medium containing instructions for controlling a computing device to map first categories of a first taxonomy to second categories of a second taxonomy, by a method comprising:
calculating a similarity score between each first category and each second category, the similarity score being based on a term-frequency-by-inverse-document-frequency metric of text associated with the first category and text associated with a second category; and
generating a mapping from each first category to the second category with a similarity score indicating that it is most similar to the first category.

19. The computer-readable medium of claim 18 wherein when the similarity score indicates that a first category is not similar to any second category, mapping the first category to a second category based on a mapping of an ancestor category of the first category to a second category.

20. The computer-readable medium of claim 18 wherein the first taxonomy is a standard industry code and the second taxonomy is a target taxonomy.
